(19) United States
(12) Patent Application Publication
(10) Pub. No.: US 2023/0306744 A1
(43) Pub. Date: Sep. 28, 2023

(54) LEARNING MODEL GENERATION DEVICE, LEARNING MODEL GENERATION METHOD, AND RECORDING MEDIUM

(71) Applicant: NEC Corporation, Minato-ku, Tokyo (JP)

(72) Inventors: Rina Tomita, Tokyo (JP); Yuji Tahara, Tokyo (JP)

(73) Assignee: NEC Corporation, Minato-ku, Tokyo (JP)

(21) Appl. No.: 18/018,786

(22) PCT Filed: Jul. 31, 2020
(86) PCT No.: PCT/JP2020/029495

§ 371 Date: Jan. 30, 2023

(51) Int. Cl. G06V 20/52; G06V 10/774; G06T 7/62; H04N 7/18; G06Q 20/20

(52) U.S. Cl. CPC G06V 20/52; G06V 10/774; G06T 7/62; H04N 7/188; G06Q 20/203; G06T 2207/30232; G06T 2207/20081; G06T 2207/30242

(57) ABSTRACT

A learning model generation device is provided with: an inventory information acquisition unit for acquiring, from a POS terminal in a store, inventory information including an inventory quantity of products for which a payment is made; an image acquisition unit for acquiring an image of a shelf of the products in the store; and a model generation unit for generating a model to estimate the number of products from the image on the basis of the image and the inventory quantity of the products.

### TECHNICAL FIELD

The present disclosure relates to a learning model generation device, a learning model generation system, a learning model generation method, and a learning model generation program.

### BACKGROUND ART

Currently, problem of securing store employees due to labor shortage is becoming more serious. In such an environment, it is desired to develop a technology for saving labor such as product inventory management and product replenishment work on shelfs and reducing the burden on employees.

In order to detect shortage and display disturbance of products displayed on a shelf or the like in a store, a method of detecting them using a learning model having learned from images of displayed products is known.

A large amount of product images (training data) are required to generate a learning model for detecting product shortage or display disturbance, but it is difficult to obtain a large amount of high-quality training data.

PTL 1 discloses a method of synthesizing a background image and an object image to generate an image for learning in an image analysis system using machine learning.

PTL 2 discloses a method of generating an image for machine learning training from data such as a vector model and a 3D model using a neural network.

### CITATION LIST

### Patent Literature

[PTL 1] JP 2014-178957 A
[PTL 2] JP 2019-159630 A

### SUMMARY OF INVENTION

### Technical Problem

However, PTLs 1 and 2 do not disclose a technology for detecting product shortage or display disturbance in a store. In order to acquire image data of a product in a store, it is necessary to set a capturing condition for each store. Even when an image of a certain product is captured, a shelf for use is different for each store, or even if the shelf is the same, an orientation of the product and a display method are different when the product is displayed. Therefore, if a learning model is caused to learn using, as learning data, an image captured at one place, false recognition is likely to occur in detection of product shortage or display disturbance in each store, and detection accuracy is deteriorated. It is difficult to efficiently capture a large number of high-quality learning images for each store.

One of the objects of the present disclosure is to solve the above problem and to provide a technology for efficiently acquiring high-quality learning data relating to products, and generating a learning model with high detection accuracy in a store.

### Solution to Problem

A learning model generation device according to one aspect of the present disclosure includes:
an inventory information acquisition unit for acquiring, from a POS terminal in a store, inventory information including an inventory quantity of a product for which payment has been made;
an image acquisition unit for acquiring an image of a shelf of the products in the store; and
a model generation unit for generating a model to estimate the product quantity from the image based on the image and the inventory quantity of the products.

A learning model generation system in one aspect of the present disclosure includes:
the learning model generation device according to above;
a camera that captures and transmits, to the learning model generation device, the image; and
the POS terminal.

A learning model generation method in one aspect of the present disclosure includes:
acquiring inventory information including an inventory quantity of a product for which payment has been made from a POS terminal of a store;
acquiring an image of a shelf on which the product is displayed in the store; and
generating a model for estimating a product quantity from the image based on the image and an inventory quantity of the product.

A recording medium storing a learning model generation program in one aspect of the present disclosure causes a computer to implement:
acquiring inventory information including an inventory quantity of a product for which payment has been made from a POS terminal of a store;
acquiring an image of a shelf on which the product is displayed in the store; and
generating a model for estimating a product quantity from the image based on the image and an inventory quantity of the product.

The program may be stored in a non-transitory computer-readable recording medium.

A discretionary combinations of the above constituent elements and modifications of the expressions of the present disclosure among methods, devices, systems, recording media, computer programs, and the like are also effective as aspects of the present disclosure.

Various constituent elements of the present disclosure do not necessarily need to be individually independent. A plurality of constituent elements may be formed as one member, one constituent element may be formed of a plurality of members, a certain constituent element may be a part of another constituent element, a part of a certain constituent element may overlap a part of another constituent element, and the like.

While the method and the computer program of the present disclosure describe a plurality of procedures in order, the order of description does not limit the order of executing the plurality of procedures. Therefore, when the method and the computer program of the present disclosure are implemented, the order of the plurality of procedures can be changed within a range in which there is no problem in content.

Furthermore, the plurality of procedures of the method and the computer program of the present disclosure are not limited to being executed at individually different timings. Therefore, another procedure may occur during execution of a certain procedure. The execution timing of a certain procedure and the execution timing of another procedure may partially or entirely overlap each other.

### Advantageous Effects of Invention

An effect of the present disclosure is to be able to efficiently acquire high-quality learning data relating to products, and generates a learning model with high detection accuracy in a store.

### BRIEF DESCRIPTION OF DRAWINGS

FIG. 1 is a view conceptually illustrating a configuration example of a learning model generation system according to a first example embodiment of the present disclosure.

FIG. 2 is a view illustrating an internal configuration example of a learning model generation device and a POS terminal according to the first example embodiment of the present disclosure.

FIG. 3 is a view illustrating a data structure example of inventory information.

FIG. 4 is a view illustrating a data structure example of image information.

FIG. 5 is a view illustrating an example of a shelf image of a shelf.

FIG. 6 is a view illustrating an example of a shelf image of a shelf.

FIG. 7 is a flowchart illustrating an operation example of the learning model generation device according to the first example embodiment of the present disclosure.

FIG. 8 is a view illustrating an internal configuration example of a learning model generation device according to a second example embodiment of the present disclosure.

FIG. 9 is a flowchart illustrating an operation example of the learning model generation device according to the second example embodiment of the present disclosure.

FIG. 10 is a view illustrating an example of a conversion table.

FIG. 11 is a view illustrating an internal configuration example of a learning model generation device according to a third example embodiment of the present disclosure.

FIG. 12 is a block diagram illustrating a hardware configuration example of a computer that implements each device of the learning model generation system.

### EXAMPLE EMBODIMENT

Hereinafter, example embodiments of the present disclosure will be described with reference to the drawings. In all the drawings, the same constituent elements are denoted by the same reference signs, and the description will be omitted as appropriate. In the following drawings, configurations of parts not involved in the essence of the present disclosure are omitted and not illustrated.

In example embodiments, “acquisition” includes at least one of a case where an own device fetches data or information stored in another device or a recording medium (active acquisition), and a case where data or information output from another device is input to the own device (passive acquisition). Examples of the active acquisition include requesting or inquiring another device and receiving a reply thereto, and accessing and reading another device or a recording medium. Examples of passive acquisition include receiving information to be distributed (alternatively, transmission, push notification, and the like). Furthermore, “acquisition” may be to selection and acquisition from among received data or information, or selection and reception of distributed data or information.

### First Example Embodiment

(Learning Model Generation System)

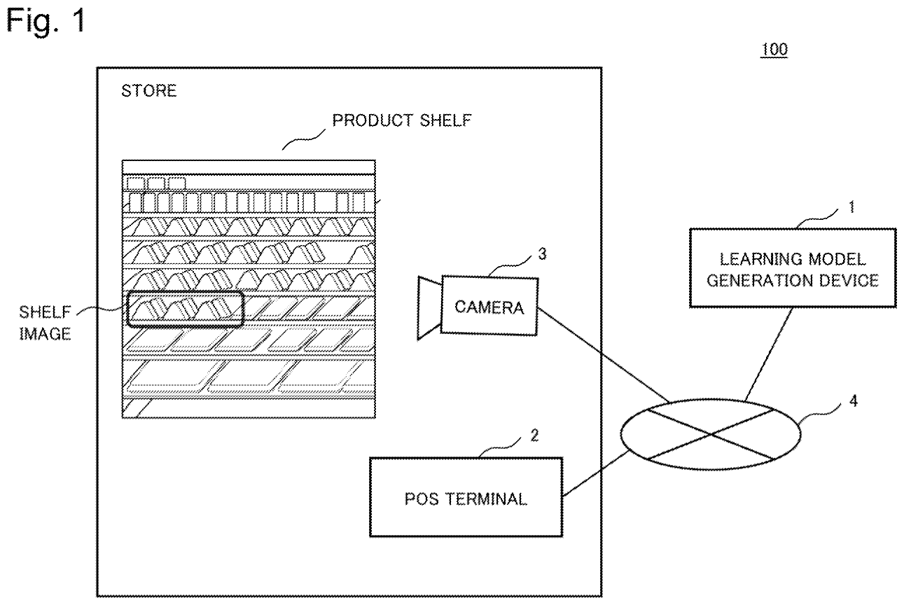

FIG. 1 is a block diagram conceptually illustrating a configuration example of a learning model generation system 100 according to the first example embodiment of the present disclosure. The learning model generation system 100 includes a learning model generation device 1, a POS terminal 2, and a camera 3. The camera 3 and the POS terminal 2 are connected to the learning model generation device 1 via a communication network 4 such as the Internet or an intranet. The learning model generation device 1 may be provided in a store and connected to the camera 3 and the POS terminal 2 by a wired cable or the like.

The camera 3 is a camera provided for each store and capturing an image of a shelf. The camera 3 may be a camera including a fisheye lens and capturing a wide area. The camera 3 may be a camera having a mechanism for moving in the store. The camera 3 may be a camera owned by a store clerk. There may be a plurality of the cameras 3, and each camera 3 captures a shelf image that is a section of the shelf.

Operation of the learning model generation system 100 will be described. The POS terminal 2 executes payment of a certain product. When the POS terminal 2 notifies the learning model generation device 1 of the payment, the learning model generation device 1 causes the camera 3 to capture and acquire an image of the product. This is because the inventory quantity and the display state of the product are changed due to the payment of the product. By acquiring an image of a product using such a change as a trigger, it is possible to efficiently acquire a learning image and cause the learning model to learn.

(Learning Model Generation Device)

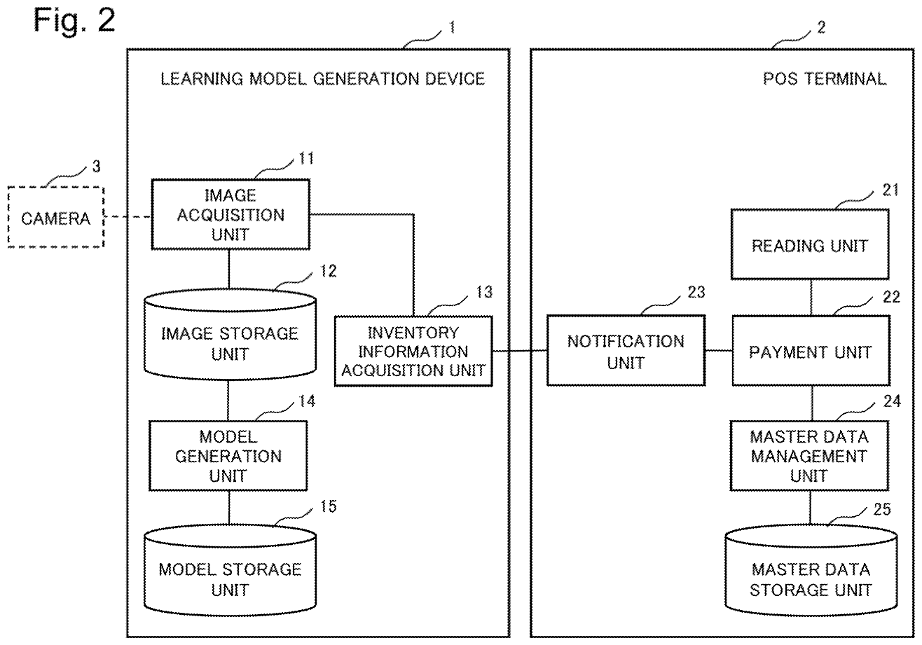

Next, an example of internal structures of the learning model generation device 1 and the POS terminal 2 will be described with reference to FIG. 2.

The learning model generation device 1 includes an image acquisition unit 11, an image storage unit 12, an inventory information acquisition unit 13, a model generation unit 14, and a model storage unit 15.

The image acquisition unit 11 acquires a shelf image that is of one section of the shelf on which the product is displayed, captured by the camera 3. In the image, there are a product and a background (such as a shelf). The image acquisition unit 11 stores the acquired image into the image storage unit 12 together with information regarding the image (hereinafter, also described as image information).

The image storage unit 12 stores the image and the image information acquired from the image acquisition unit 11.

The inventory information acquisition unit 13 acquires the inventory quantity of a product for which payment has been made from the POS terminal 2 of the store. When the payment of the product is performed in the POS terminal 2, the inventory information acquisition unit 13 acquires inventory information including the inventory quantity of the product from the POS terminal 2 and delivers the inventory information to the image acquisition unit 11.

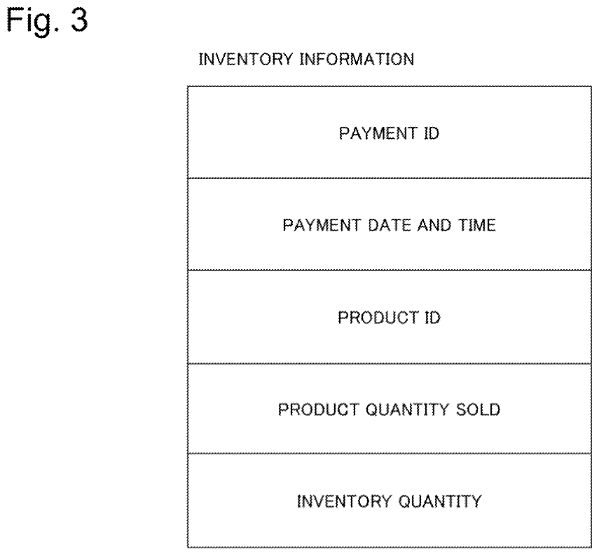

The inventory information will be described with reference to FIG. 3. The inventory information includes, for example, a payment ID, a payment date and time, a product ID, a product quantity sold, and inventory quantity. The payment ID is an identifier for uniquely identifying the payment, and may be a sequential number of the payment occurrence order. The payment date and time is a date and time when the payment is executed. The payment date and time may be acquired from a time stamp function included in the POS terminal 2. The product ID is an identifier for uniquely identifying the product. The product ID may be acquired from a product master data (details will be described later) included in the POS terminal 2. A product name corresponding to the product ID may be given. The product quantity sold is a product quantity having been sold (paid). The inventory quantity is the inventory quantity of the product after payment. The product quantity sold and the inventory quantity may be acquired from a sales master data or an inventory master data (details will be described later) included in the POS terminal 2.

Upon receiving the inventory information, the image acquisition unit 11 causes the camera 3 to capture an image of the shelf, generates image information regarding the captured image, and stores the image and the image information in association with each other into the image storage unit 12.

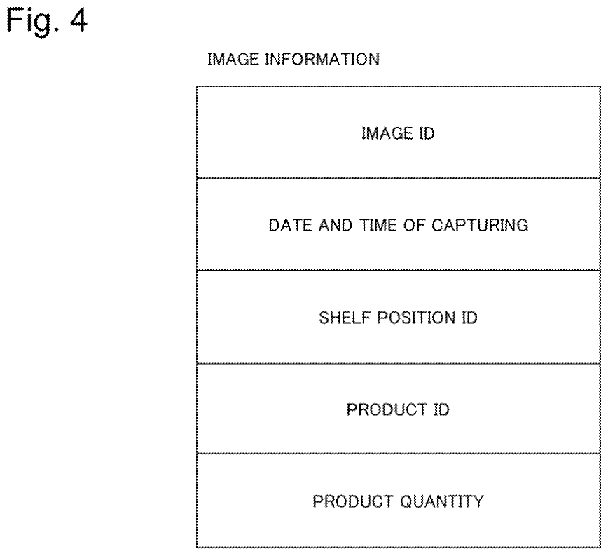

The image information will be described with reference to FIG. 4. The image information includes, for example, an image identifier (ID), a date and time of capturing, a shelf position ID, a product ID, and a product quantity.

The image ID is an identifier for uniquely identifying the image. For example, it may be sequential numbers of the order of capturing. When there are a plurality of the cameras 3, a camera ID for uniquely identifying the camera may be assigned to the image ID. For example, a 100th image captured by a camera A is given “Image ID: A-100”.

The date and time of capturing is the date and time when the camera 3 captured the shelf image. This may use a time stamp function provided in the camera 3. Since it is possible to determine the date and time of capturing of the image, it is possible to select a shelf image of the latest date and time of capturing or extract a shelf image captured in a specific date and time or period.

The shelf position ID is an identifier for specifying the position of an image in the store. For example, it is assumed that there are 10 shelfs (shelf numbers 1 to 10) in a certain store A, and the shelfs are classified into sections 1 to 5. In such a case, the shelf position ID whose image indicates an image of the section 3 with shelf number 5 is, for example, “A (store)—5 (shelf)—3 (section)”.

The product ID is an identifier for identifying the product appearing in the image. In acquisition of the product ID of a product appearing in a certain shelf image, information as to what product to be displayed at a corresponding shelf position may be given in advance, or information (for example, a product code) of a product tag given to the front surface of the shelf in the image may be read by the image acquisition unit 11 and automatically input. Alternatively, an image recognition engine may be mounted on the camera 3 or the learning model generation device 1, and the product and the product ID may be specified by image recognition processing. A plurality of products may be appearing in one image. For example, when canned juice A (product ID: KA) and canned juice B (product ID: KB) are appearing in an image, two product IDs KA and KB are given as product IDs.

The product quantity is the number of products included in the image. The image acquisition unit 11 inputs, as the product quantity, the inventory quantity included in the inventory information.

The inventory information acquisition unit 13 acquires the inventory quantity of the product at the time of acquiring the image from the POS terminal 2. That is, as a result of the product payment in the POS terminal 2, with reception of the inventory information after payment by the inventory information acquisition unit 13 from the POS terminal 2 as a trigger, the image acquisition unit 11 acquires an image of the shelf after payment. The image acquisition unit 11 requests the camera 3 to capture an image including a product having the same product ID as the product ID included in the inventory information.

That is, with the payment of a product in the POS terminal 2 as a trigger, the image acquisition unit 11 acquires the image after payment, and the inventory information acquisition unit 13 acquires the inventory quantity of the product after payment.

The product quantity included in the image captured after payment is the same as the inventory quantity of the products included in the inventory information after payment. A specific example will be described. It is assumed that the products of chicken skewers (product ID: Y) Y1, Y2, Y3, and Y4 (inventory quantity of 4) are arranged side by side in a shelf (for example, a hot shelf), the chicken skewer Y1 is purchased (paid) at 12:00, and the chicken skewer Y2 is purchased at 12:05. In this case, the inventory information acquisition unit 13 acquires inventory information (product ID: Y, inventory quantity: 3) from the POS terminal 2 immediately after payment of the chicken skewer Y1, the camera 3 captures an image A of the chicken skewers Y2, Y3, and Y4 with the acquisition of the inventory information as a trigger, and the image acquisition unit 11 acquires the image A. At this time, since the inventory quantity of 3 included in the inventory information is equal to the number of the chicken skewers Y2, Y3, and Y4 included in the image A, the “image A” and the “3 chicken skewers (Y2, Y3, and Y4)” are stored in the image storage unit 12 in association with each other. Next, also immediately after the purchase of the chicken skewer Y2 at 12:05, similarly, with the reception of inventory information (product ID: Y, inventory quantity: 2) from the POS terminal 2 as a trigger, the image acquisition unit 11 acquires an image B of the chicken skewers Y3 and Y4 captured by the camera 3, and the “image B” and the “2 chicken skewers (Y3 and Y4)” are stored in the image storage unit 12 in association with each other. Thus, images immediately after payment are stored as learning images in association with a product and a product quantity in time series. Due to this, high-quality learning data is automatically acquired for each payment.

The model generation unit 14 generates a model for estimating the number of products from an image based on the image and the inventory quantity of the products. The model generation unit 14 acquires an image and image information corresponding to the image from the image storage unit 12. The image information includes a product ID and a product quantity. The model generation unit 14 acquires a model from the model storage unit 15, and causes the image and the image information (the product and the product quantity included in the image) to be learned. Execution of learning may be performed after a predetermined amount of images are stored in the image storage unit 12, may be performed every predetermined number of days, or may be performed every payment.

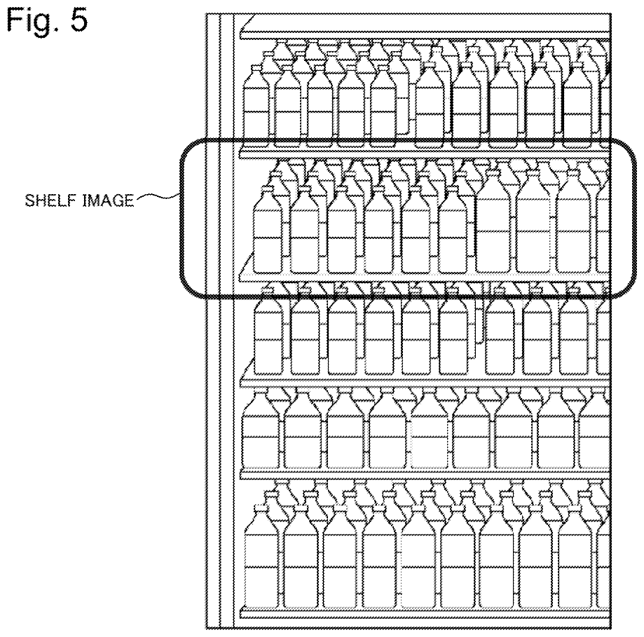

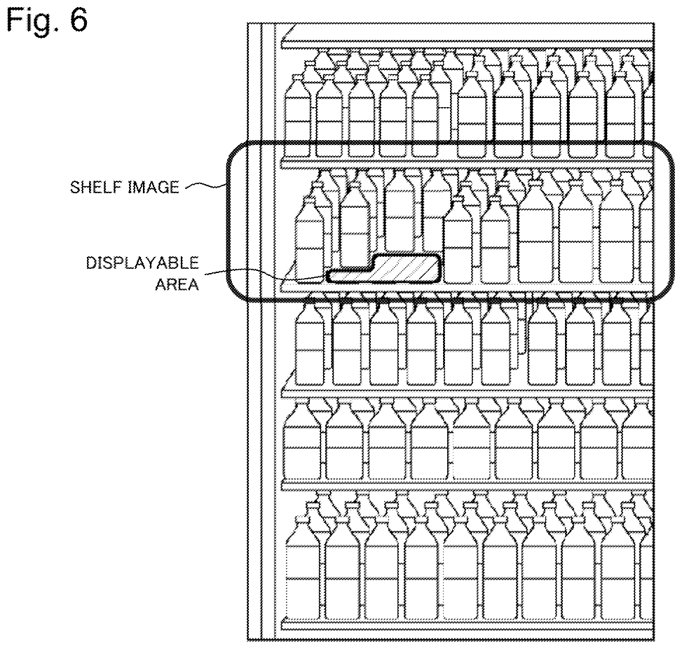

The learning processing of the model generation unit 14 will be described. A model includes a first model configured to learn a difference (first difference) between a displayable area where a certain product at a certain date and time of capturing can be displayed and a displayable area where the product can be displayed at a date and time of capturing after a predetermined period has elapsed from the above-described date and time of capturing. For example, FIGS. 5 and 6 show a shelf and a shelf image of a product of plastic bottle. Although there is no displayable area in the shelf image illustrated in FIG. 5, a displayable area is generated in the shelf image (see FIG. 6) after a predetermined period has elapsed. Therefore, the first model is configured to learn the area (area, position, and the like in the displayable area in FIG. 6) that is the first difference.

The model further includes a second model. The second model calculates a difference (second difference) between the inventory quantity of the product of plastic bottle at the date and time of capturing of the shelf image of FIG. 5 and the inventory quantity of the same at the date and time of capturing of the shelf image of FIG. 6, based on these pieces of image information, and associates the difference with the first difference. For example, when the inventory quantity in FIG. 5 is 50 and the inventory quantity in FIG. 6 is 45, the second difference (quantity) corresponding to the first difference (area) in the product of plastic bottle is associated with 5.

The model storage unit 15 stores the models (the first model and the second model) generated by the model generation unit 14.

An example of the internal structure of the POS terminal 2 will be described with reference to FIG. 2. The POS terminal 2 includes a reading unit 21, a payment unit 22, a notification unit 23, a master data management unit 24, and a master data storage unit 25.

The reading unit 21 is a scanner device or the like for reading a barcode or the like of a product. In the checkout-free system (unmanned payment system), determination processing using image analysis technology or weight analysis technology, such as an action of picking up a product and putting the product in a basket that is regarded as product purchase may also be included as the processing of the reading unit 21. After reading the product, the payment unit 22 performs payment processing such as cash payment and credit-card payment. The notification unit 23 generates inventory information (see FIG. 3) after completion of payment and transmits the inventory information to the learning model generation device 1. The master data management unit 24 manages a product master data including detailed information of a product, a sales master data including sales information of the product, an inventory master data including inventory information of the product, and the like. The master data storage unit 25 stores the product master data, the sales master data, the inventory master data, and the like. In addition, the POS terminal 2 may include a keyboard (not illustrated) for the store clerk to input a numerical value and the like and a display (not illustrated) for displaying the payment amount.

(Operation of Learning Model Generation Device)

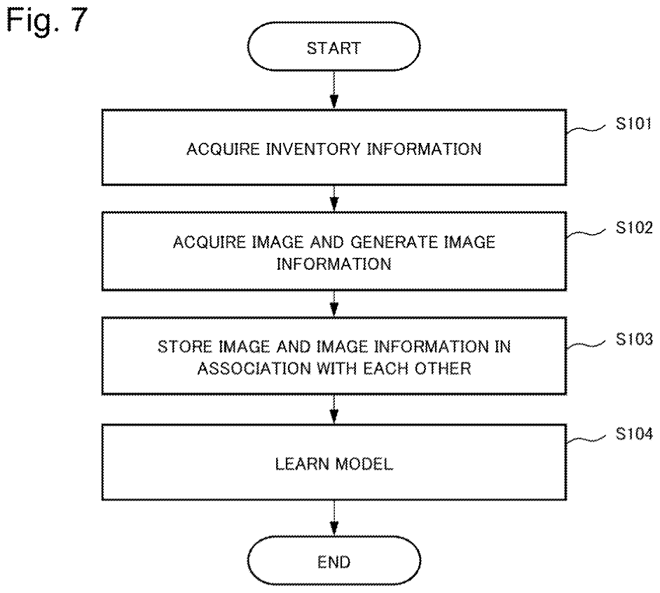

The operation of the learning model generation device 1 in the learning model generation system 100 will be described with reference to the flowchart illustrated in FIG. 7. As a premise, it is assumed that the payment unit 22 of the POS terminal 2 has executed payment of a product in a store, and the notification unit 23 has generated inventory information based on the payment and transmitted the inventory information to the learning model generation device 1.

First, in step S101, the inventory information acquisition unit 13 (see FIG. 2) of the learning model generation device 1 acquires inventory information from the POS terminal 2.

In step S102, the image acquisition unit 11 acquires an image and generates image information. Specifically, the image acquisition unit 11 causes the camera 3 to capture a shelf image corresponding to the product ID included in the inventory information, and acquires the captured shelf image. Furthermore, the image acquisition unit 11 generates image information from the inventory information and the acquired shelf image.

In step S103, the image acquisition unit 11 stores the acquired image and the generated image information in association with each other into the image storage unit 12.

In step S104, the model generation unit 14 acquires an image and image information from the image storage unit 12, and acquires a model from the model storage unit 15. The model generation unit 14 causes the model to learn based on the image and the inventory quantity of the product, and generates a model for estimating the product quantity from the image.

As described above, the operation of the learning model generation device 1 in the learning model generation system 100 ends.

(Effects of First Example Embodiment)

According to the first example embodiment of the present disclosure, it is possible to efficiently acquire high-quality learning data relating to products, and generates a learning model with high detection accuracy in a store. This is because the inventory information acquisition unit 13 acquires the inventory quantity of the product for which payment has been made from the POS terminal of the store, the image acquisition unit 11 acquires the image of the shelf on which the product is displayed in the store, and the model generation unit 14 generates the model for estimating the product quantity from the image based on the image and the inventory quantity of the product.

### Second Example Embodiment

In the first example embodiment, a method of causing a model to learn by using an image and image information after payment in time series has been described. This method is effective in a case where a customer does not change the position of a product, or in a shelf on which a store clerk mainly picks up a product such as a hot shelf or a tobacco shelf. However, in a case where the product is at a position where the customer can directly pick up one, the position of the product sometimes changes even though there is no change in the inventory quantity, for example, the product picked up by the customer is returned to a position different from the original position. In such a situation, it is effective to capture and acquire a shelf image before and after payment, particularly immediately before and after payment, in terms of being able to acquire an image in which the product position other than the product to be purchased does not change. This is because, in learning, the clearer a notable change (decrease in purchased products) is, the better a learning image is. Therefore, in the second example embodiment, a method of capturing shelf images before and after payment and generating a learning model will be described.

(Learning Model Generation System)

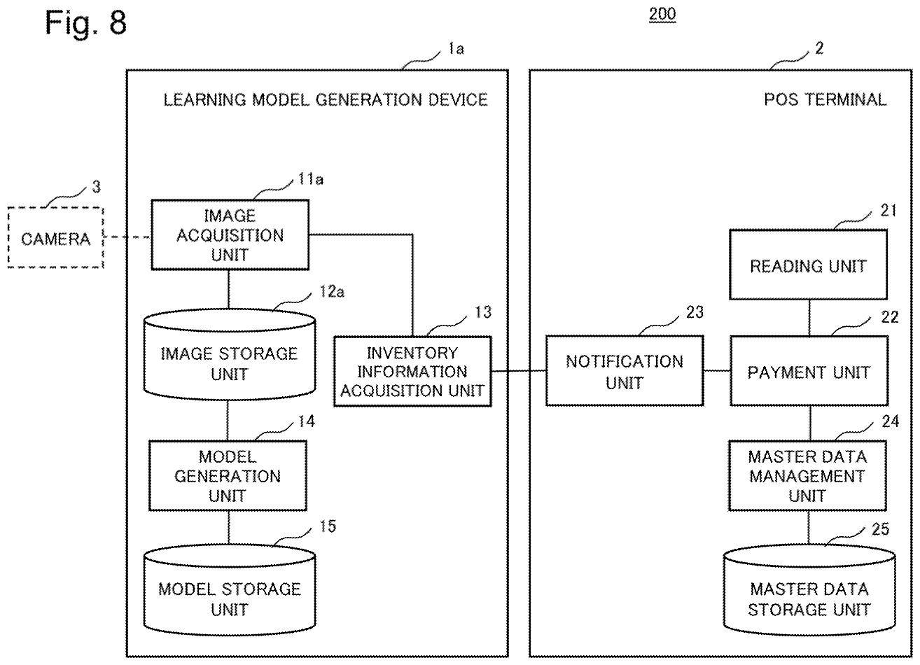

FIG. 8 is a view illustrating a configuration example of a learning model generation system 200 according to the second example embodiment of the present disclosure. The learning model generation system 200 includes a learning model generation device 1a, the POS terminal 2, and the camera 3. Similarly to FIG. 1, the camera 3 and the POS terminal 2 may be connected to the learning model generation device 1a via the communication network 4 such as the Internet or an intranet, or the learning model generation device 1a may be provided in a store and connected to the camera 3 and the POS terminal 2 by a wired cable or the like.

(Learning Model Generation Device)

Next, an example of an internal structure of the learning model generation device 1a will be described with reference to FIG. 8.

The learning model generation device 1a includes an image acquisition unit 11a, an image storage unit 12a, the inventory information acquisition unit 13, the model generation unit 14, and the model storage unit 15.

The image acquisition unit 11a continuously acquires shelf images that is of one section of the shelf on which the product is displayed, captured by the camera 3. For example, the camera 3 captures continuously captured images (for example, video) of the shelf images, and the image acquisition unit 11a acquires the video. The video may be a frame-by-frame image. A time stamp of capturing time is given to the video. Video capturing by the camera 3 may be performed only in a predetermined time (for example, from 12:00 to 13:00 with the largest sales). The image acquisition unit 11a stores the acquired video into the image storage unit 12a.

The image storage unit 12a temporarily stores the video. The video may be erased at regular intervals (for example, every day).

When the inventory information acquisition unit 13 receives the inventory information from the POS terminal 2 and the inventory information acquisition unit 13 delivers the inventory information to the image acquisition unit 11a, the image acquisition unit 11a acquires the payment date and time included in the inventory information, and acquires, from the video stored in the image storage unit 12a, shelf images before and after payment date and time. For example, in a case where the payment date and time is 12:10:10, an image M of 12:10:05 before payment and an image N of 12:10:15 after payment are acquired from the image storage unit 12a. That is, images before and after payment are acquired at a shorter time interval (immediately before and immediately after payment date and time) than that in the first example embodiment.

The image acquisition unit 11a generates image information (see FIG. 4) based on the inventory information (see FIG. 3) for each of images (image M and image N) before and after payment with the payment as a trigger. Since the inventory information is notified every time payment occurs, the inventory quantity included in the inventory information notified one time before is only required to be used for the inventory quantity before payment. The image acquisition unit 11a stores, into the image storage unit 12a, the image before payment and its image information, and the image after payment and its image information.

In this manner, by storing the images before payment and after payment as learning images in association with the product and its product quantity, high-quality learning data is automatically acquired for each payment.

The configurations of other devices and units in the learning model generation system 200 are similar to those of the first example embodiment.

(Operation of Learning Model Generation Device)

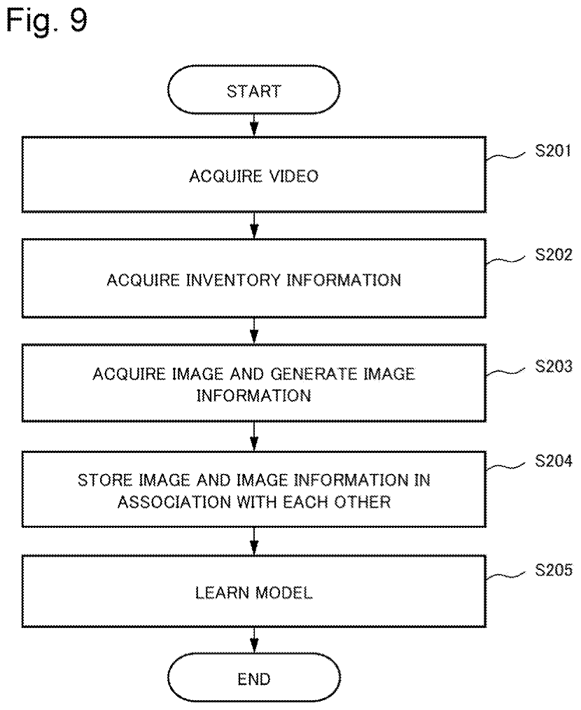

The operation of the learning model generation device 1a in the learning model generation system 200 will be described with reference to the flowchart illustrated in FIG. 9. As a premise, it is assumed that the payment unit 22 of the POS terminal 2 has executed payment of a product in a store, and the notification unit 23 has generated inventory information based on the payment and transmitted the inventory information to the learning model generation device 1a.

First, in step S201, the image acquisition unit 11a of the learning model generation device 1a acquires a video of a shelf image from the camera 3. The image acquisition unit 11a stores the acquired video into the image storage unit 12a.

In step S202, the inventory information acquisition unit 13 acquires inventory information from the POS terminal 2. The inventory information acquisition unit 13 delivers the inventory information to the image acquisition unit 11a.

In step S203, upon acquiring the inventory information, the image acquisition unit 11a acquires the payment date and time included in the inventory information, and acquires shelf images before and after payment date and time from the video stored in the image storage unit 12a. The image acquisition unit 11a generates image information for each of the images before and after payment date and time based on the inventory information (see FIG. 3).

In step S204, the image acquisition unit 11a stores, into the image storage unit 12a, the image before payment and its image information, and the image after payment and its image information in association with each other.

In step S205, the model generation unit 14 acquires the images before and after payment and their image information from the image storage unit 12a, and acquires a model from the model storage unit 15. The model generation unit 14 causes the model to learn based on the images before and after payment and the inventory quantity of the product, and generates a model for estimating the product quantity from the image.

As described above, the operation of the learning model generation device 1a in the learning model generation system 200 ends.

(Effects of Second Example Embodiment)

According to the second example embodiment of the present disclosure, even when a customer moves a product in a store, it is possible to efficiently acquire high-quality learning data relating to products, and generates a learning model with high detection accuracy. This is because the inventory information acquisition unit 13 acquires the inventory quantity of the product for which payment has been made from the POS terminal of the store, the image acquisition unit 11a acquires each image of the shelf on which the product is displayed before and after payment, and the model generation unit 14 generates the model for estimating the product quantity from the image based on the image and the inventory quantity of the product. By capturing and acquiring shelf images before and after payment, it is possible to acquire an image in which the product position other than the product to be purchased does not change. Therefore, in learning, a notable change (decrease in purchased products) becomes clearer, and the model can be caused to learn based on a better learning image.

<Modifications>

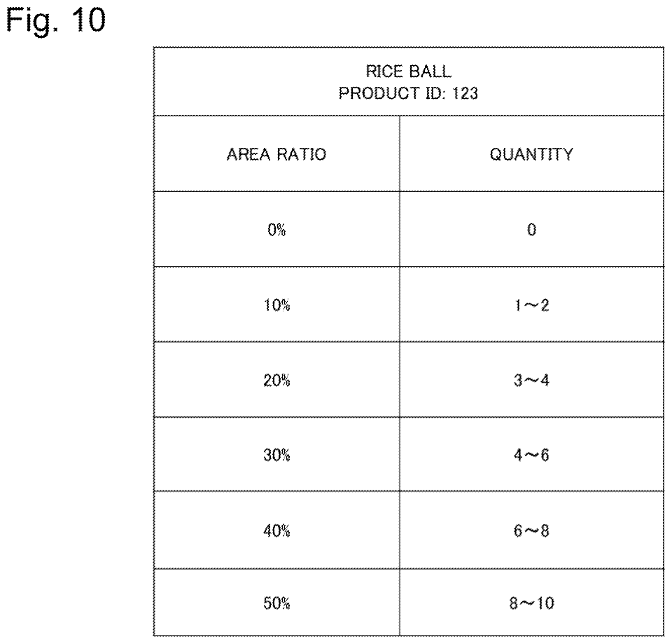

In the first example embodiment and the second example embodiment, the model generation unit 14 causes the model to learn. In particular, the second model is configured to learn association between the first difference and the second difference for a certain product based on the first difference, which is a change in an area before and after payment for the certain product, and the second difference, which is a difference in the inventory quantity before and after payment. At this time, the second model may create a conversion table in which a change in the area of a certain product and a change in the product quantity are associated with each other as illustrated in FIG. 10. The conversion table may be updated with an improvement of detection accuracy of the second model. In FIG. 10, the area ratio is a ratio of an area occupied by a product image in a shelf image. The quantity is a number indicating the product quantity included in the shelf image. For example, in a case of the area ratio of 10% of the conversion table, the area ratio of the product image in the shelf image is 10%, and the product quantity appearing in the shelf image is estimated to be 1 or 2. By creating and further updating the conversion table in this manner, it is possible to increase the calculation speed of the second model.

### Third Example Embodiment

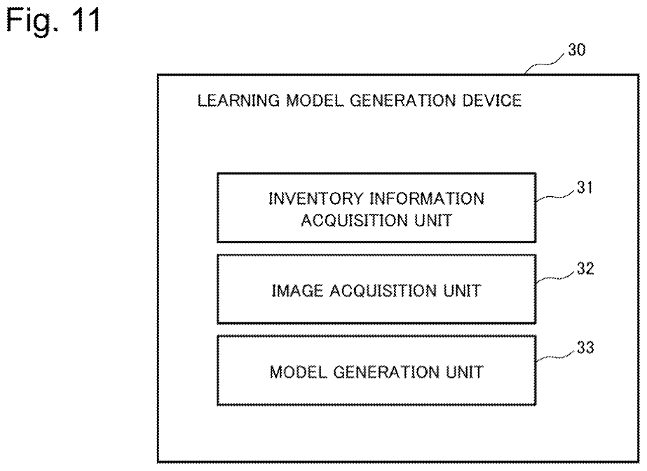

A learning model generation device 30 according to the third example embodiment of the present disclosure will be described with reference to FIG. 11. The learning model generation device 30 is a minimum configuration mode of the first example embodiment and the second example embodiment.

The learning model generation device 30 includes an inventory information acquisition unit 31, an image acquisition unit 32, and a model generation unit 33.

The inventory information acquisition unit 31 acquires inventory information including the inventory quantity of a product for which payment has been made from the POS terminal in the store. The image acquisition unit 32 acquires an image of a shelf on which a product is displayed in the store. The model generation unit 33 generates a model for estimating the product quantity from the image based on the image and the inventory quantity of the product.

According to the third example embodiment of the present disclosure, it is possible to efficiently acquire high-quality learning data relating to products, and generates a learning model with high detection accuracy in a store. This is because when the inventory information acquisition unit 31 acquires the inventory information including the inventory quantity of the product for which payment has been made from the POS terminal in the store, the image acquisition unit 32 acquires an image of a shelf on which the product is displayed in the store. This is because furthermore the model generation unit 33 generates the model for estimating the product quantity from the image based on the image and the inventory quantity of the product.

<Hardware Configuration>

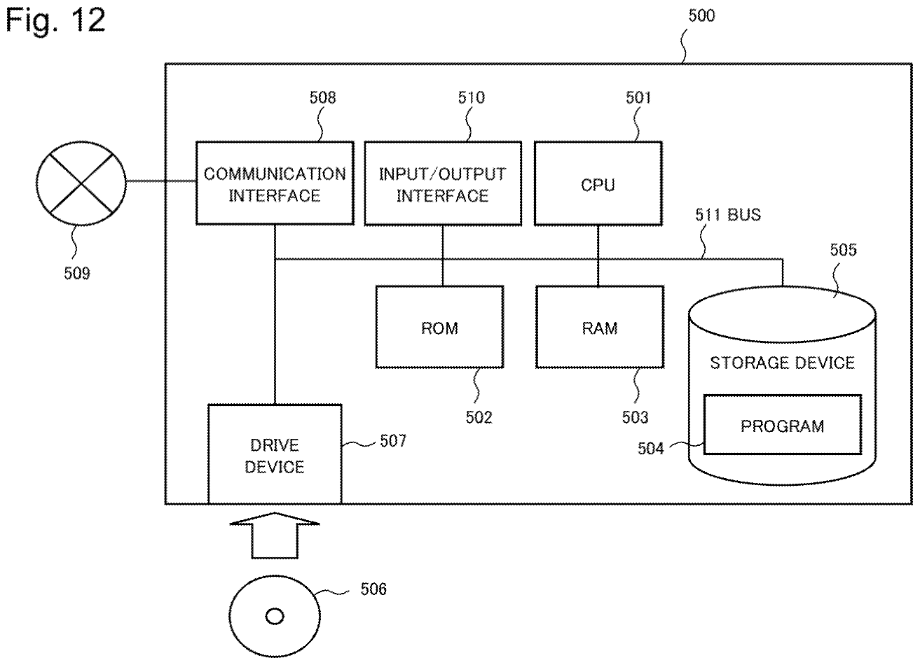

In each example embodiment of the present disclosure, each constituent element of each device (learning model generation devices 1, la, 30, or the like) included in the learning model generation systems 100 or 200 indicates a block of a functional unit. Some or all of those constituent elements of each device are implemented by a discretionary combination of an information processing device 500 and a program as illustrated in FIG. 12, for example. The information processing device 500 includes the following configuration as an example.
CPU (central processing unit) 501
ROM (read only memory) 502
RAM (random access memory) 503
Program 504 loaded into RAM 503
Storage device 505 storing program 504
Drive device 507 that reads and writes recording medium 506
Communication interface 508 connected with communication network 509
Input/output interface 510 for inputting/outputting data
Bus 511 connecting each constituent element

Each constituent element of each device in each example embodiment is implemented by the CPU 501 acquiring and executing the program 504 that implements these functions. The program 504 for implementing the function of each constituent element of each device is stored in advance in the storage device 505 or the RAM 503, for example, and is read by the CPU 501 as necessary. The program 504 may be supplied to the CPU 501 via the communication network 509, or may be stored in advance in the recording medium 506, and the drive device 507 may read the program and supply the program to the CPU 501.

There are various modifications for the implementation method of each device. For example, each device may be implemented by a discretionary combination of a separate information processing device 500 and a separate program for each constituent element. A plurality of constituent elements included in each device may be implemented by a discretionary combination of one information processing device 500 and a program.

Some or all of the constituent elements of each device are implemented by another general-purpose or dedicated circuit, processor, or the like, or a combination of them. These may be configured by a single chip or may be configured by a plurality of chips connected via a bus.

Some or all of the constituent elements of each device may be implemented by a combination of the above-described circuit and the like and program.

In a case where some or all of the constituent elements of each device are implemented by a plurality of information processing devices, circuits, and the like, the plurality of information processing devices, circuits, and the like may be arranged in a centralized manner or in a distributed manner. For example, the information processing device, the circuit, and the like may be implemented as a form in which they are connected via a communication network, such as a client and server system or a cloud computing system.

A part or the entirety of the above-described example embodiments can be described as the following supplementary notes, but are not limited to the following.

### [Supplementary Note 1]

A learning model generation device including:
an inventory information acquisition unit that acquires, from a POS terminal in a store, inventory information including an inventory quantity of a product for which payment has been made;
an image acquisition unit that acquires an image of a shelf of the products in the store; and
a model generation unit that generates a model to estimate the product quantity from the image based on the image and the inventory quantity of the products.

### [Supplementary Note 2]

The learning model generation device according to Supplementary Note 1, in which
with payment of the product in the POS terminal as a trigger,
the inventory information acquisition unit acquires the inventory information, and
the image acquisition unit acquires the image after the payment.

### [Supplementary Note 3]

The learning model generation device according to Supplementary Note 1 or 2, in which
with payment of the product in the POS terminal as a trigger,
the image acquisition unit acquires the image before the payment.

### [Supplementary Note 4]

The learning model generation device according to Supplementary Note 3, in which
the image before the payment is acquired from continuously captured images.

### [Supplementary Note 5]

The learning model generation device according to Supplementary Note 1, in which
the model includes
a first model configured to learn a first difference between a displayable area where the product on the shelf before the payment can be displayed in the product and the displayable area after the payment.

### [Supplementary Note 6]

The learning model generation device according to Supplementary Note 5, in which
the model includes
a second model configured to learn association between the first difference and a second difference for the product based on the first difference and the second difference between an inventory quantity before the payment and an inventory quantity after the payment in the product.

### [Supplementary Note 7]

The learning model generation device according to Supplementary Note 6, in which
the second model
creates a conversion table in which the first difference and the second difference for the product are associated with each other.

### [Supplementary Note 8]

A learning model generation system including:
the learning model generation device according to any of Supplementary Notes 1 to 7;
a camera that captures and transmits, to the learning model generation device, the image; and
the POS terminal.

### [Supplementary Note 9]

A learning model generation method including:
acquiring inventory information including an inventory quantity of a product for which payment has been made from a POS terminal of a store;
acquiring an image of a shelf on which the product is displayed in the store; and
generating a model for estimating a product quantity from the image based on the image and an inventory quantity of the product.

### [Supplementary Note 10]

The learning model generation method according to Supplementary Note 9, in which
with payment of the product in the POS terminal as a trigger,
acquiring the inventory information acquires the inventory information, and
acquiring an image of the shelf acquires the image after the payment.

### [Supplementary Note 11]

The learning model generation method according to Supplementary Note 9 or 10, in which
with payment of the product in the POS terminal as a trigger,
acquiring an image of the shelf acquires the image before the payment.

### [Supplementary Note 12]

The learning model generation method according to Supplementary Note 11, in which
the image before the payment is acquired from continuously captured images.

### [Supplementary Note 13]

The learning model generation method according to Supplementary Note 9, in which
the model includes
a first model configured to learn a first difference between a displayable area where the product on the shelf before the payment can be displayed in the product and the displayable area after the payment.

### [Supplementary Note 14]

The learning model generation method according to Supplementary Note 13, in which
the model includes
a second model configured to learn association between the first difference and a second difference for the product based on the first difference and the second difference between an inventory quantity before the payment and an inventory quantity after the payment in the product.

### [Supplementary Note 15]

The learning model generation method according to Supplementary Note 14, in which
the second model
creates a conversion table in which the first difference and the second difference for the product are associated with each other.

### [Supplementary Note 16]

A recording medium storing a learning model generation program for causing a computer to implement:
acquiring inventory information including an inventory quantity of a product for which payment has been made from a POS terminal of a store;
acquiring an image of a shelf on which the product is displayed in the store; and
generating a model for estimating a product quantity from the image based on the image and an inventory quantity of the product.

### [Supplementary Note 17]

The recording medium according to Supplementary Note 16, wherein
with payment of the product in the POS terminal as a trigger,
acquiring the inventory information acquires the inventory information, and
acquiring an image of the shelf acquires the image after the payment.

### [Supplementary Note 18]

The recording medium according to Supplementary Note 16 or 17, in which
with payment of the product in the POS terminal as a trigger,
acquiring an image of the shelf acquires the image before the payment.

### [Supplementary Note 19]

The recording medium according to Supplementary Note 18, in which
the image before the payment is acquired from continuously captured images.

### [Supplementary Note 20]

The recording medium according to Supplementary Note 16, in which
the model includes
a first model configured to learn a first difference between a displayable area where the product on the shelf before the payment can be displayed in the product and the displayable area after the payment.

### [Supplementary Note 21]

The recording medium according to Supplementary Note 20, in which
the model includes
a second model configured to learn association between the first difference and a second difference for the product based on the first difference and the second difference between an inventory quantity before the payment and an inventory quantity after the payment in the product.

### [Supplementary Note 22]

The recording medium according to Supplementary Note 21, in which
the second model
creates a conversion table in which the first difference and the second difference for the product are associated with each other.

While the invention of the present application has been described above with reference to the example embodiments and examples, the present invention is not limited to the above example embodiments and examples. Various modifications that can be understood by those skilled in the art can be made to the configuration and details of the present invention within the scope of the present invention.

### REFERENCE SIGNS LIST

1 learning model generation device
1a learning model generation device
2 POS terminal
3 camera
4 communication network
11 image acquisition unit
11a image acquisition unit
12 image storage unit
12a image storage unit
12b image storage unit
13 inventory information acquisition unit
14 model generation unit
14 model generation unit
15 model storage unit
21 reading unit
22 payment unit
23 notification unit
24 master data management unit
25 master data storage unit
30 learning model generation device
31 inventory information acquisition unit
32 image acquisition unit
33 model generation unit
100 learning model generation system
200 learning model generation system
500 information processing device
501 CPU
502 ROM
503 RAM
504 program
505 storage device
506 recording medium
507 drive device
508 communication interface
509 communication network
510 input/output interface
511 bus

What is claimed is:

1. A learning model generation device comprising:
one or more memories storing instructions; and
one or more processors configured to execute the instructions to:
acquire inventory information including an inventory quantity of a product for which payment has been made from a POS (Point Of Sales) terminal in a store and an image of a shelf of the products in the store; and
generate a model to estimate the product quantity from the image based on the image and the inventory quantity of the products.

2. The learning model generation device according to claim 1, wherein the one or more processors configured to execute the instructions to:
with payment of the product in the POS terminal as a trigger, acquire the inventory information and the image acquisition means acquires the image after the payment.

3. The learning model generation device according to claim 1, wherein the one or more processors configured to execute the instructions to:
with payment of the product in the POS terminal as a trigger, acquire the image before the payment.

4. The learning model generation device according to claim 3, wherein
the image before the payment is acquired from continuously captured images.

5. The learning model generation device according to claim 1, wherein
the model includes
a first model configured to learn a first difference between a displayable area where the product on the shelf before the payment can be displayed in the product and the displayable area after the payment.

6. The learning model generation device according to claim 5, wherein
the model includes
a second model configured to learn association between the first difference and a second difference for the product based on the first difference and the second difference between an inventory quantity before the payment and an inventory quantity after the payment in the product.

7. The learning model generation device according to claim 6, wherein
the second model
creates a conversion table in which the first difference and the second difference for the product are associated with each other.

8. (canceled)

9. A learning model generation method comprising:
acquiring inventory information including an inventory quantity of a product for which payment has been made from a POS terminal of a store and an image of a shelf on which the product is displayed in the store; and
generating a model for estimating a product quantity from the image based on the image and an inventory quantity of the product.

10. The learning model generation method according to claim 9, wherein
with payment of the product in the POS terminal as a trigger, acquiring acquires the inventory information and the image after the payment.

11. The learning model generation method according to claim 9, wherein
with payment of the product in the POS terminal as a trigger, acquiring acquires the image before the payment.

12. The learning model generation method according to claim 11, wherein
the image before the payment is acquired from continuously captured images.

13. The learning model generation method according to claim 9, wherein
the model includes
a first model configured to learn a first difference between a displayable area where the product on the shelf before the payment can be displayed in the product and the displayable area after the payment.

14. The learning model generation method according to claim 13, wherein
the model includes
a second model configured to learn association between the first difference and a second difference for the product based on the first difference and the second difference between an inventory quantity before the payment and an inventory quantity after the payment in the product.

15. The learning model generation method according to claim 14, wherein
the second model
creates a conversion table in which the first difference and the second difference for the product are associated with each other.

16. A recording medium storing a learning model generation program for causing a computer to implement:
acquiring inventory information including an inventory quantity of a product for which payment has been made from a POS terminal of a store and an image of a shelf on which the product is displayed in the store; and
generating a model for estimating a product quantity from the image based on the image and an inventory quantity of the product.

17-22. (canceled)

23. The learning model generation device according to claim 1, wherein the one or more processors configured to execute the instructions to:
with payment of the product in the POS terminal as a trigger, acquire the inventory information, the image before the payment and the image after the payment.

24. The learning model generation device according to claim 23, wherein
the image before the payment is acquired from continuously captured images.

25. The learning model generation device according to claim 24, wherein
the model includes
a first model configured to learn a first difference between a displayable area where the product on the shelf before the payment can be displayed in the product and the displayable area after the payment.

26. The learning model generation device according to claim 25, wherein
the model includes
a second model configured to learn association between the first difference and a second difference for the product based on the first difference and the second difference between an inventory quantity before the payment and an inventory quantity after the payment in the product.

27. The learning model generation device according to claim 26, wherein
the second model
creates a conversion table in which the first difference and the second difference for the product are associated with each other.
